(19) United States
(12) Patent Application Publication
(10) Pub. No.: US 2002/0089253 A1
(43) Pub. Date: Jul. 11, 2002

(54) Winding support for use with a superconducting rotor and method for forming the same

(76) Inventor: Henry William Kudlacik, Mineville, NY (US)

Correspondence Address: NIXON & VANDERHYE P.C., 1100 North Gelebe Road, 8th Floor, Arlington, VA, 22201, US

(21) Appl. No.: 09/757,701

(22) Filed: Jan. 11, 2001

(51) Int. Cl. H02K 3/46; H02K 1/12

(52) U.S. Cl. 310/260; 310/258

(57) ABSTRACT

A winding support structure for use with a superconducting rotor support structure and method for forming the same comprises a binding ring and a lamination coupled to the binding ring and having a slot formed therein for receiving the winding. At least one tie is arranged around a portion of the lamination and a portion of the binding ring to enable the winding to be held within the slot. The lamination includes a first tooth and a second tooth integral with the lamination for defining the slot therebetween. A felt ring or a tire is arranged around an outer circumference of the binding ring. Alternatively, the winding support structure comprises a binding ring, first and second non-magnetic boards coupled to the binding ring and a lamination coupled to the boards. A slot is defined between the boards and between the binding ring and the lamination to receive the winding. Any clearance space in the slot is filled with an RTV or an epoxy.

This invention was made with government support under government contract no. DEFC0293CH10589 awarded by the Department of Energy. The government has certain rights to this invention.

### BACKGROUND OF THE INVENTION

This invention relates to electric machines such as electric power generators and electric motors, and in particular to a stator winding support structure for use with a superconducting rotor.

In order to generate current, an electric generator typically includes a rotor and a stator, each of which contains a winding. The rotor is conventionally arranged within the stator to define an air gap therebetween. The stator conventionally includes a frame and a cylindrically-shaped core having magnetic teeth on its inner circumference. The teeth of the stator core form a plurality slots which receive the stator winding and therefore provide radial and tangential support. The teeth of the stator core provide a grounding plane since the stator winding contacts the teeth. The teeth of the stator core, however, are not desirable or needed when the rotor winding is formed by a superconducting winding that produces a very strong magnetic field. In the absence of the teeth, the stator winding is arranged within the magnetic field and thus produce both tangential and radial pulsating forces imposed on itself. While the tangential forces provide useful torque during normal operation, the radial forces produce an undesirable stator winding vibration.

It would thus be beneficial to provide a support structure for a stator winding for use with a superconducting rotor which is separated by an air gap from the rotor and which transmits the torque between the rotor and stator while preventing stator winding vibration. The support structure holds the stator winding radially against the stator core to prevent winding vibration.

### BRIEF SUMMARY OF THE INVENTION

In accordance with an exemplary embodiment of the present invention, a winding support structure for use with a superconducting rotor comprises a binding ring, a lamination coupled to the binding ring and having a slot formed therein for receiving the winding, and a tie coupled to the lamination and the binding ring to enable the winding to be held within the slot. The tie is arranged around a portion of the lamination and a portion of the binding ring. The lamination includes a first tooth and a second tooth integrally formed therewith, the slot being formed between the first tooth and the second tooth. The lamination also includes a third tooth integral with the lamination so that another slot is formed between the second tooth and the third tooth to receive the winding. A felt ring or a tire is arranged around an outer circumference of the binding ring so that the felt ring or tire is arranged between the binding ring and the lamination. The support structure further includes another tie coupled to the binding ring. The support structure transmits the air gap torque between a rotor and stator to the frame while preventing winding vibration.

In accordance with another exemplary embodiment of the present invention, the winding support structure for use with a superconducting rotor comprises a binding ring, first and second non-magnetic boards coupled to said binding ring and a lamination coupled to the non-magnetic boards. A slot is defined between the first and second boards and between the binding ring and lamination for receiving a winding. Any clearance space in the slot is filled with an RTV or an epoxy. A tire is arranged around an outer circumference of the binding ring so that the tire is arranged between the binding ring, the laminations and winding. The winding support structure further comprises a third non-magnetic board coupled to the lamination and the binding ring so that another slot may be defined between the second and third non-magnetic boards and between the binding ring and the lamination. Another binding ring is coupled to the first and second non-magnetic boards. The support structure of the another exemplary embodiment transmits the air gap torque between a rotor and stator to the frame while preventing winding vibration.

In accordance with yet another exemplary embodiment of the present invention, a method of forming a winding support structure for use with a superconducting rotor comprises providing a binding ring, forming a slot in a lamination to receive the winding, and coupling the lamination to the binding ring by arranging a tie around a portion of the lamination and a portion of the binding ring to enable the winding to be held within the slot. Forming the slot in the lamination includes forming a first tooth and a second tooth integral with the lamination, the slot being formed between the first tooth and the second tooth. A third tooth is formed integral with the lamination to define another slot between the second tooth and the third tooth. A felt ring or a tire is arranged around a circumference of the binding ring so that the felt ring or tire is arranged between the binding ring and the lamination. Another tie is coupled to the binding ring.

In accordance with yet another exemplary embodiment of the present invention, a method of forming a winding support structure for use with a superconducting rotor comprises providing a binding ring, coupling first and second non-magnetic boards to the binding ring and coupling a lamination to the first and second non-magnetic boards so that a slot for receiving a winding is defined between the first and second non-magnetic boards and between the binding ring and the lamination. Any clearance space in the slot is filled with an RTV or an epoxy. A tire is arranged around an outer circumference of the binding ring so that it is arranged between the binding ring and the lamination. A third non-magnetic board is coupled to the binding ring and the lamination so that another slot is defined for receiving the winding between the second and third non-magnetic boards and between the binding ring and the lamination. Another binding ring is coupled to the first and second nonmagnetic boards.

### BRIEF DESCRIPTION OF THE DRAWINGS

These, as well as other objects and advantages of this invention, will be more completely understood and appreciated by careful study of the following more detailed description of the presently preferred exemplary embodiments of the invention taken in conjunction with the accompanying drawings, in which:

FIG. 1 is a top view of, inter alia, a winding support structure in accordance with an exemplary embodiment of the present invention;

FIG. 2 is a cutaway view illustrating details of the winding support structure shown in FIG. 1;

FIG. 3 is a partial cross-sectional view illustrating details of the winding support structure shown in FIG. 1;

FIG. 4 is a top view of, inter alia, a winding support structure in accordance with a further exemplary embodiment of the present invention;

FIG. 5 is a cutaway view illustrating details of the winding support structure shown in FIG. 4; and

FIG. 6 is a partial cross-sectional view of illustrating details of the winding support structure shown in FIG. 4.

### DETAILED DESCRIPTION OF THE INVENTION

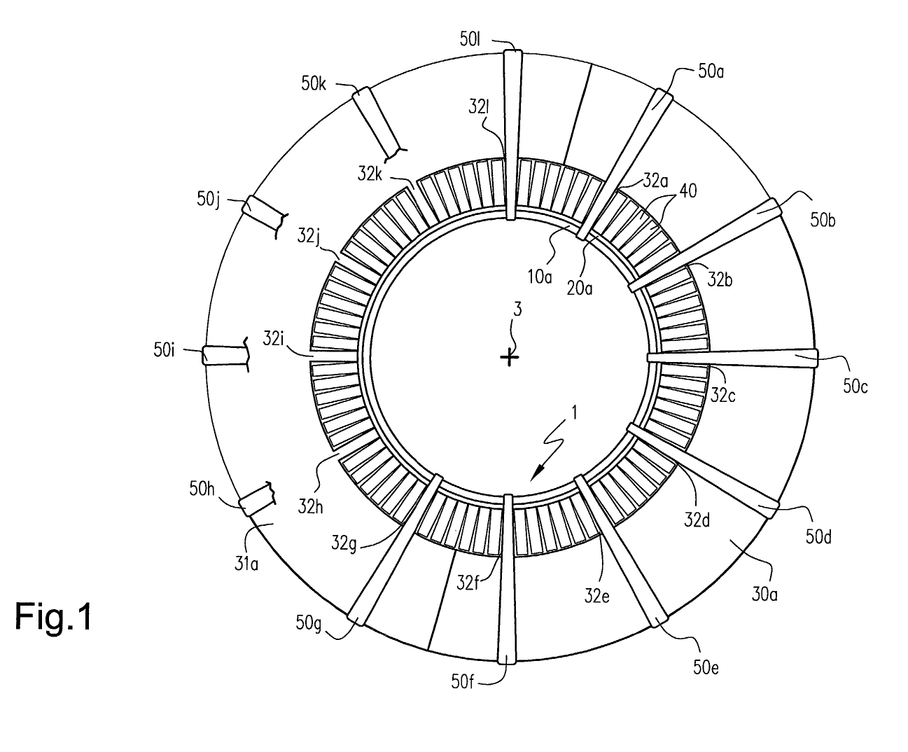

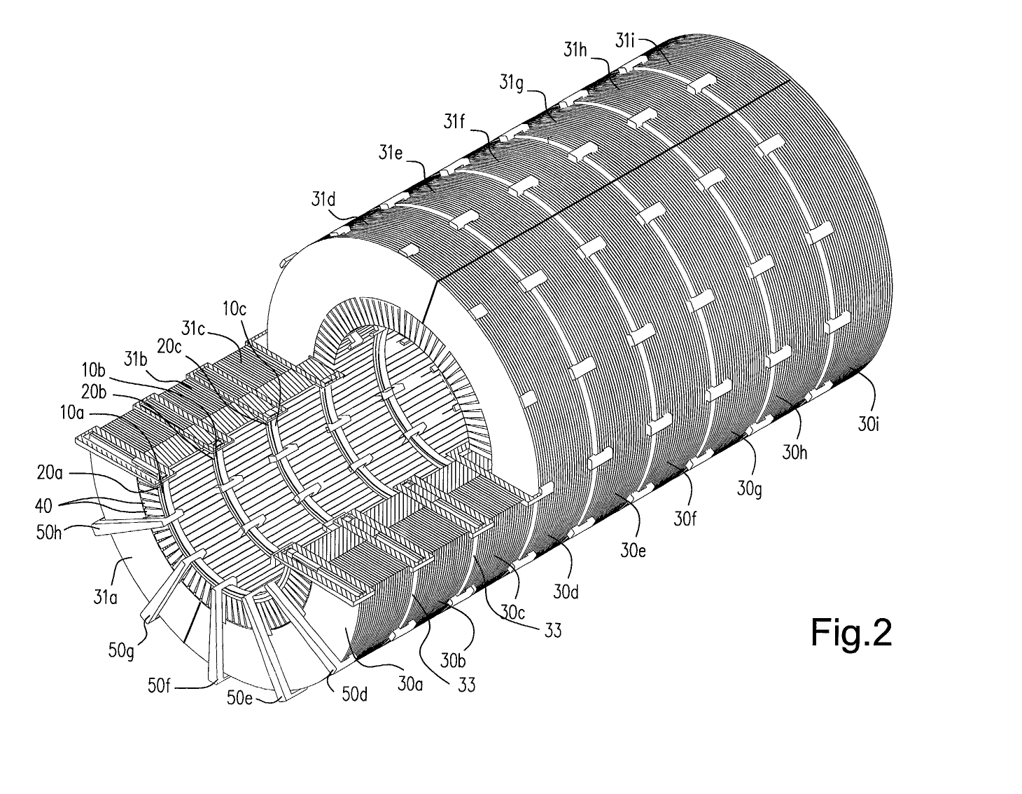

FIGS. 1 and 2 illustrates a partial cross-sectional view of a winding support structure 1 in accordance with an exemplary embodiment of the present invention. The winding support structure 1 can be used, for example, in a 100 MVA or larger generator having a superconducting rotor (not shown) and a stator. The support structure 1 supports a stator winding 40 comprising a plurality of bars so that the support structure 1 transmits torque between the rotor and stator and prevents stator winding vibration while being in the presence of a strong magnetic field produced by the superconducting rotor. The bars of the winding 40 are formed, cooled, insulated and grounded in a conventional manner. In a preferred embodiment, the bars of the stator winding 40 are formed in a single layer.

The support structure 1 includes a plurality of binding rings 10a-10c, a plurality of dacron felt rings 20a-20c, a plurality of stacked laminations 30a-30i, 31a-31i and a plurality of glass ties 50a-50l. To provide clarity, not all of the binding rings and felt rings forming the support structure 1 are shown in FIGS. 1-2. The binding rings 10a-10c are centered about a longitudinal axis 3 of the support structure 1 and are spaced axially apart along the direction of the longitudinal axis 3. The binding rings 10a-10c have a strength to withstand any forces resulting from the operation of the generator. The felt rings 20a-20c are respectively arranged around the outer circumferences of the binding rings 10a-10c. The laminations are supported by key bars (not shown) which are supported by the frame.

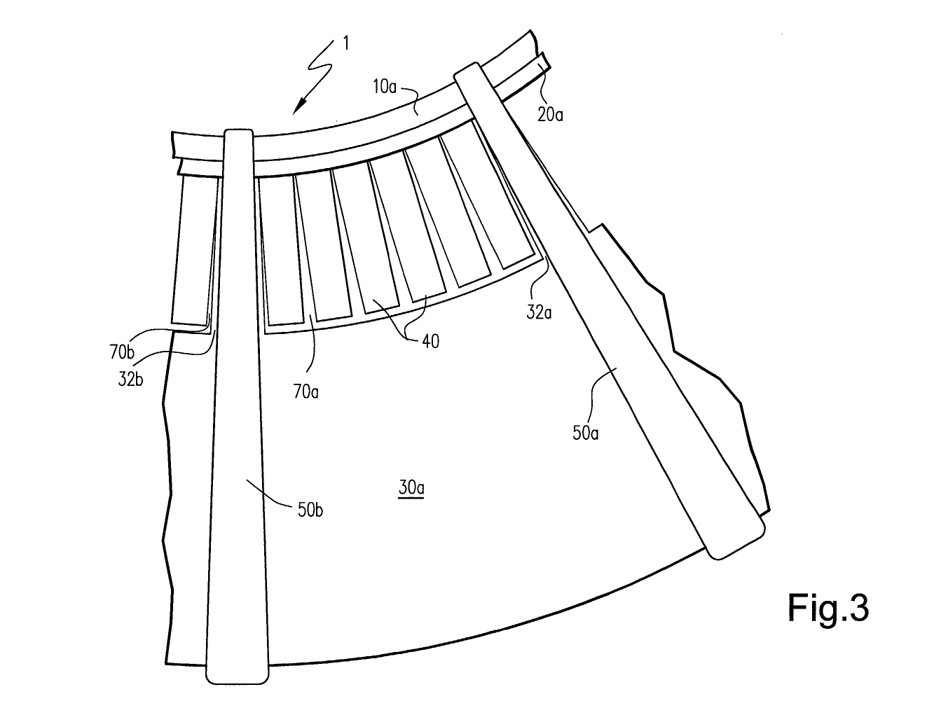

Each of the laminations 30a-30i, 31a-31i comprises a plurality of thin stacked punchings (see FIG. 3). Each of the laminations 30a-30i, 31a-31i forms a semi-circle magnetic portion such that two of the laminations can form a complete circumference of the support structure 1 (e.g., laminations 30a, 31a form a complete circumference). Those skilled in the art, however, will appreciate that the complete circumferences can be formed by dividing the laminations into more than two semi-circle portions. The laminations 30b-30i, 31b-31i are stacked in the axial direction (i.e., along the direction parallel to the longitudinal axis 3) with respect to laminations 30a, 31a, respectively, to form the core of the stator.

Water cooling pads 33 are interposed between each of the laminations 30a-30i, 31a-31i in the axial direction to provide cooling of the laminations. Each of the laminations 30a-30i, 31a-31i include a plurality of magnetic teeth integrally formed therewith. For example, laminations 30a, 31a include magnetic teeth 32a-32l as illustrated FIG. 1. The magnetic teeth have a size necessary to transmit the winding torque between the rotor and stator via the laminations 30a-30i, 31a-31i forming the stator core. The number of magnetic teeth in each lamination 30a-30i, 31a-31i is determined by the pressure of the winding on the magnetic teeth. In operation, the each of the magnetic teeth will magnetically saturate but the losses in laminations will be acceptable.

While the discussion below focuses primarily on only one lamination 30a, one binding ring 10a, one felt ring 20a and first and second ties 50a, 50b in detail, those skilled in the art will understand that similar comments apply to the other laminations, binding rings, felt rings and ties that are a part of the support structure 1.

Referring now to FIG. 3 which shows a portion of the support structure 1 in detail, the lamination 30a is preferably formed of magnetic steel and has a plurality of slots formed (e.g., punched) in its inner periphery. One of the slots 70a is defined on opposite sides by a first magnetic tooth 32a and a second magnetic tooth 32b that are both integral with the lamination 30a. A portion of the winding 40, preferably formed in a single layer, is inserted into the slot 70a. For example, six bars of the winding 40 are arranged between the first magnetic tooth 32a and the second magnetic tooth 32b in the exemplary embodiment shown in FIG. 3. The clearance for the winding 40 in the slot 70a is minimal to prevent the winding 40 from vibrating.

The inner ends of the first and second magnetic teeth 32a, 32b are arranged so that they contact the dacron felt ring 20a. The felt ring 20a is arranged around the outer circumference of the binding ring 10a. The sides of the bars of the winding 40 which are closest to the longitudinal axis 3 are also arranged so that they contact the felt ring 20a. Six bars of the winding 40 are thus received into the slot 70a which is defined by the first and second magnetic teeth 32a, 32b in the circumferential direction, and the dacron felt ring 20a (and hence the binding ring 10a) and a face of the lamination 30a in the radial direction.

After a portion of the winding 40 is arranged in slot 70a, the winding 40 is held in place by arranging a plurality of ties 50a, 50b around a portion of the lamination 30a, the binding ring 10a and the felt ring 20a. Specifically, ties 50a and 50b are respectively arranged around magnetic teeth 32a and 32b of the lamination 30a in the radial direction. The ties 50a, 50b extend on the inner diameter of the lamination 30a in the axial direction around some of the punchings forming the lamination 30a. The ties 50a, 50b extend in the radial direction from the inner diameter to the outer diameter of the lamination 30a via a respective Aluminum spacers (not shown) which essentially provide respective pathways for the ties 50a, 50b to extend in the radial direction and which provide heat transfer from the stator core. Similarly, the binding ring 10b and felt ring 20b have respective ties (shown but unlabeled) arranged around them and around some of the punchings forming the laminations 31a, 31b. The ties 50a, 50b enable the winding 40 to be held in the slot 70a to prevent vibration of the winding 40.

As illustrated in FIGS. 1 and 3, the lamination 30a includes a third magnetic tooth 32c. Another slot 70b is thus defined between the second magnetic tooth 32b and the third magnetic tooth 32c and between the felt ring 20a (and hence the binding ring 10a) and the lamination 30a. Like slot 70a, the slot 70b receives the winding 40 with a minimal amount of clearance space so that the winding 40 does not vibrate.

In an alternative embodiment, the felt ring 20a is replaced by a hose-type tire. Like the felt ring 20a, the tire is arranged around the outer circumference of the binding ring 10a. The tire is thus arranged between the binding ring 10a and the laminations 30a, 31a. The tire is filled with a fluid or a conforming material. One end of a fluid fill tube arranged outside of the generator allows fluid within the tire to be maintained at predetermined pressure for long periods of time. The tire may also be filled with a material which solidifies.

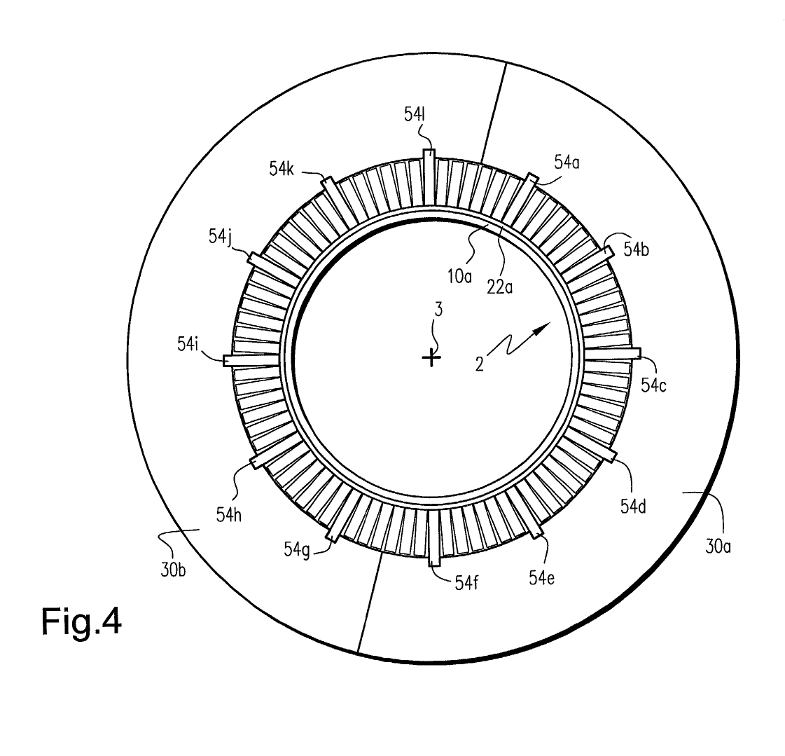

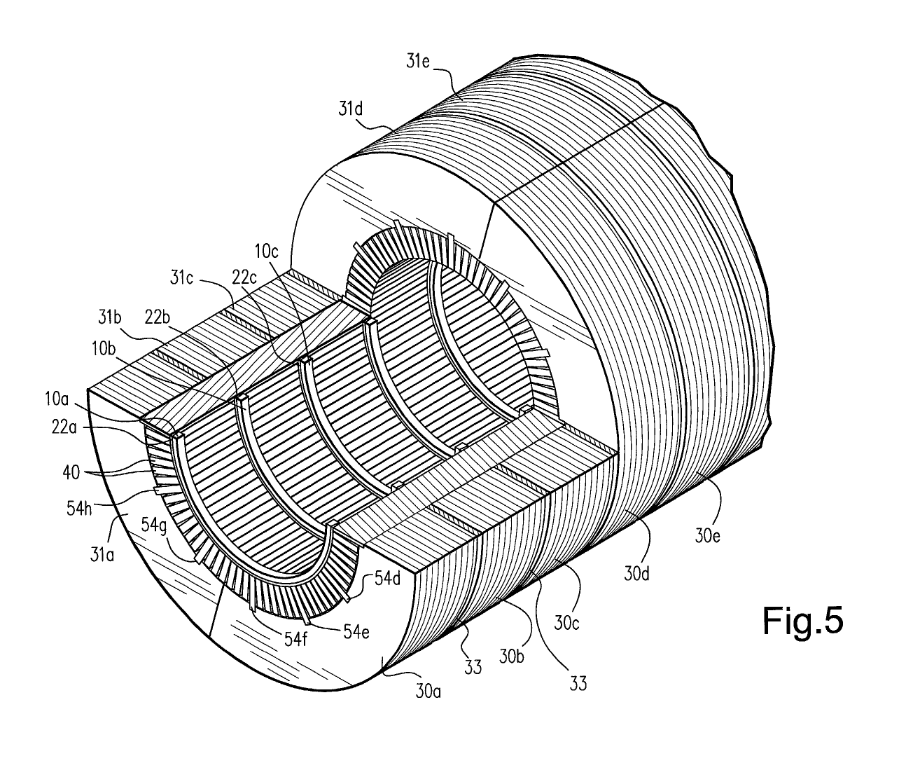

FIGS. 4-5 illustrates a support structure 2 according to an alternate exemplary embodiment of the present invention wherein reference numbers corresponding to elements previously described remain the same and only the differences will be discussed in detail. Similar to the support structure 1 discussed above, the support structure 2 includes a plurality of binding rings 10a-10c, a plurality of laminations 30a-30c, 31a-31c (other binding rings not shown) and a plurality of water cooling pads 33. The support structure 2 further includes a plurality of hose-type tires 22a-22c that are respectively arranged around the outer circumferences of the binding rings 10a-10c. Each of the tires 22a-22c is filled with a fluid, the pressure of which is maintained at a predetermined pressure through a fluid fill tube as discussed above.

Each of the laminations 30a-30c, 31a-31c has a plurality of notches formed (e.g. punched) on its inner periphery. The size of the notches is such that a plurality of non-magnetic boards 54a-54l may be engaged and held in the laminations 30a-30c, 31a-31c. Specifically, the ends of the boards 54a-54l which are radially furthest from the longitudinal axis 3 are engaged within respective notches of the laminations 30a-30c, 31a-31c with a tight fit. The non-magnetic boards 54a-54l extend the entire length of the stator core and are thus each engaged and held by each of the axially stacked laminations 30a-30c, 31a-31c. Unlike the support structure 1, the support structure 2 does not include magnetic teeth 32a-32l or ties 50a-50l.

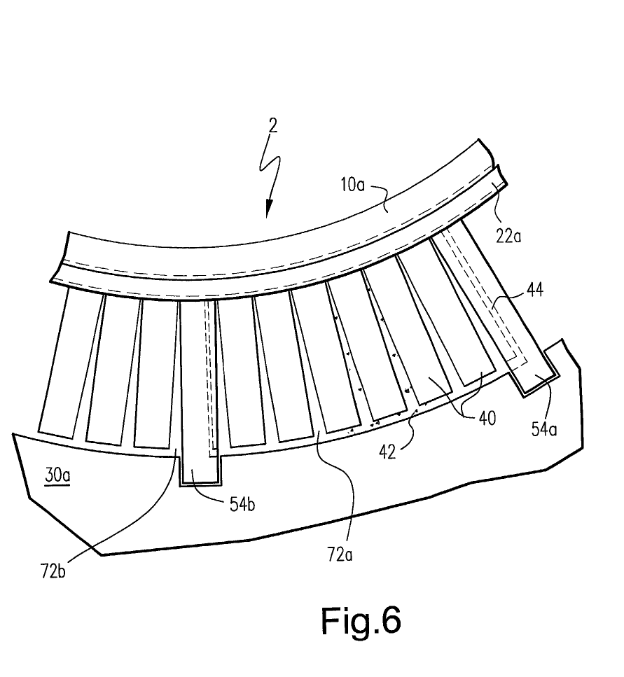

FIG. 6 shows a portion of the winding support structure 2 illustrated in FIGS. 4-5. While the discussion below focuses primarily on binding ring 10a, tire 22a, first and second non-magnetic boards 54a, 54b and lamination 30a, those skilled in the art will appreciate that similar comments apply to all others forming the support structure 2. The first and second non-magnetic boards 54a, 54b are arranged in the radial direction so that they are engaged in respective notches in the lamination 30a at their respective first ends and contact the tire 22a at their respective other ends. A slot 72a is thus defined between the first and second boards 54a, 54b in the circumferential direction and also between the tire 22a (and hence binding ring 10a) and a face of the lamination 30 in the radial direction. The slot 72a encloses a portion of the winding 40 therein. Since the boards 54a, 54b axially extend the entire length of the support structure 2, the boards 54a, 54b contact other tires (e.g., 22b-22c) and laminations (e.g., 30b-30c) which are axially spaced from tire 22a and lamination 30a, respectively, to define similar slots.

The size of the slot 72a is such that a clearance space exists when the winding 40 is enclosed therein. The clearance space extends, for example, between each the bars forming the winding 40, between the first and second non-magnetic boards 54a, 54b and the bar closest thereto, and between the lamination 30a and the bars. This clearance space is filled by an RTV or an epoxy 42 to restrict the movement of the bars caused by the electromagnetic forces of the generator and to ensure contact between the lamination 30a and the winding 40. A fill tube 44 is provided so that the RTV or the epoxy 42 may be injected into the clearance space of the slot 70a.

As illustrated in FIGS. 4 and 6, a third non-magnetic board 54c engages the lamination 30a at one end and contacts the tire 22a at its other end. Another slot 72b is thus defined between the second non-magnetic board 54b and the third non-magnetic board 54c and between the tire 22a (and hence binding ring 10a) and the lamination 30a for receiving the winding 40. Like slot 70a, the clearance space in slot 70b is filled with an RTV or an epoxy 42 through fill tube 44.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A winding support structure for use with a superconducting rotor, said support structure comprising:
a binding ring;
a lamination coupled to said binding ring, said lamination having a slot formed therein for receiving a winding; and
a tie coupled to said lamination and said binding ring to enable said winding to be held within said slot.

2. The winding support structure of claim 1 wherein said tie is arranged around a portion of said lamination and a portion of said binding ring.

3. The winding support structure of claim 1 wherein said lamination includes a first tooth and a second tooth, said slot being defined between said first tooth and said second tooth, and said first tooth and said second tooth being integral with said lamination.

4. The winding support structure of claim 3 wherein said lamination includes a third tooth integral with said lamination to define another slot between said second tooth and said third tooth to receive said winding.

5. The winding support structure of claim 1 further comprising a felt ring arranged around an outer circumference of said binding ring so that said felt ring is arranged between said binding ring and said lamination.

6. The winding support structure of claim 1 further comprising a tire arranged around an outer circumference of said binding ring so that said tire is arranged between said binding ring and said lamination.

7. The winding support structure of claim 1 further comprising another tie coupled to said binding ring.

8. A winding support structure for use with a superconducting rotor, said support structure comprising:
a binding ring;
first and second non-magnetic boards coupled to said binding ring; and
a lamination coupled to said first and second non-magnetic boards so that a slot is defined between said first and second non-magnetic boards and between said binding ring and said lamination for receiving a winding.

9. The winding support structure of claim 8 wherein a clearance space in said slot is filled with an RTV or an epoxy.

10. The winding support structure of claim 8 further comprising a tire arranged around an outer circumference of said binding ring so that said tire is arranged between said binding ring and said lamination.

11. The winding support structure of claim 8 further comprising a third non-magnetic board coupled to said lamination and said binding ring so that another slot is defined between said second and third non-magnetic boards and between said binding ring and said lamination for receiving said winding.

12. The winding support structure of claim 8 further comprising another binding ring coupled to said first and second non-magnetic boards.

13. A method of forming a winding support structure for use with a superconducting rotor comprising:
providing a binding ring;
forming a slot in a lamination to receive a winding; and
coupling said lamination to said binding ring by arranging a tie around a portion of said lamination and a portion of said binding ring to enable said winding to be held within said slot.

14. The method of claim 13 wherein forming said slot in said lamination includes forming a first tooth and a second tooth integral with said lamination, said slot being defined between said first tooth and said second tooth.

15. The method of claim 14 wherein forming said lamination includes forming a third tooth integral with said lamination to define another slot between said second tooth and said third tooth to receive said winding.

16. The method of claim 13 further comprising arranging a felt ring around an outer circumference of said binding ring so that said felt ring is arranged between said binding ring and said lamination.

17. The method of claim 13 further comprising arranging a tire around an outer circumference of said binding ring so that said tire is arranged between said binding ring and said lamination.

18. The method of claim 13 further comprising coupling another tie to said binding ring.

19. A method of forming a winding support structure for use with a superconducting rotor comprising:
providing a binding ring;
coupling first and second non-magnetic boards to said binding ring; and
coupling a lamination to said first and second non-magnetic boards so that a slot for receiving a winding is defined between said first and second non-magnetic boards and between said binding ring and said lamination.

20. The method of claim 19 further comprising filling a clearance space in said slot with an RTV or an epoxy.

21. The method of claim 19 further comprising arranging a tire around an outer circumference of said binding ring so that said tire is arranged between said binding ring and said lamination.

22. The method of claim 19 further comprising coupling a third nonmagnetic board to said binding ring and said lamination so that another slot is defined for receiving the winding between said second and third non-magnetic boards and between said binding ring and said lamination.

23. The method of claim 19 further comprising coupling another binding ring to said first and second non-magnetic boards.
